(19) United States
(12) Patent Application Publication
(10) Pub. No.: US 2025/0013922 A1
(43) Pub. Date: Jan. 9, 2025

(54) MODEL ACCELERATION METHOD, DEVICE, EQUIPMENT AND MEDIUM

(71) Applicant: BEIJING BAIDU NETCOM SCIENCE TECHNOLOGY CO., LTD., Beijing (CN)

(72) Inventor: Renyan Diao, Beijing (CN)

(73) Assignee: BEIJING BAIDU NETCOM SCIENCE TECHNOLOGY CO., LTD., Beijing (CN)

(21) Appl. No.: 18/747,131

(22) Filed: Jun. 18, 2024

(30) Foreign Application Priority Data
Nov. 20, 2023 (CN) 202311550138.4

(51) Int. Cl. G06N 20/00

(52) U.S. Cl. CPC G06N 20/00

(57) ABSTRACT

The disclosure provides a method for accelerating a model, an apparatus for accelerating a model, a device and a medium, and relates to a technical field of artificial intelligence, in particular to technical fields of deep learning and cloud service. The method includes: obtaining a model to be accelerated and acceleration-related parameters corresponding to the model to be accelerated; determining a target acceleration strategy corresponding to the model to be accelerated according to the acceleration-related parameters; determining whether there is a dependency between the model to be accelerated and a user data set; and in response to there being a dependency between the model to be accelerated and the user data set, obtaining a target user data set sent by a user, and obtaining a target model by processing the model to be accelerated based on the target user data set and the target acceleration strategy. The disclosure enables the model to better adapt to user-specific data distribution and characteristics to improve the generalization ability and accuracy of the model, so that a final deployed model is more lightweight, efficient, and adaptable to various hardware and application scenarios, therefore reducing cost and complexity of model deployment.

### TECHNICAL FIELD

The disclosure relates to a technical field of artificial intelligence (AI), in particular to technical fields of deep learning (DL) and cloud service, and provides a method for accelerating a model, an apparatus for accelerating a model, a device and a medium.

### BACKGROUND

In recent years, deep learning is widely used in computer vision (CV), natural language processing (NLP), search recommendation for advertisements, and other fields. In order to meet demand for deploying large-scale deep learning models on mobile devices, a plurality of types of inference acceleration chips are introduced to realize practical applications of artificial intelligence on the mobile devices. However, as a model size increases, the deployment of deep learning on the mobile devices faces great challenges. Especially in the background of an era of large models, increased demand for storage space, increased consumption of computing resources, and inference latency that fails to meet an ideal requirement become challenges that need to be solved urgently. Therefore, the development of model compression and acceleration techniques becomes one of the important research areas of interest to both academia and industry.

### SUMMARY

The disclosure provides a method for accelerating a model, an apparatus for accelerating a model, a device and a medium.

According to a first aspect of the disclosure, a method for accelerating a model is provided. The method includes: obtaining a model to be accelerated and acceleration-related parameters corresponding to the model to be accelerated; determining a target acceleration strategy corresponding to the model to be accelerated according to the acceleration-related parameters; determining whether there is a dependency between the model to be accelerated and a user data set; and in response to there being a dependency between the model to be accelerated and the user data set, obtaining a target user data set sent by a user, and obtaining a target model by processing the model to be accelerated based on the target user data set and the target acceleration strategy.

According to a second aspect of the disclosure, an apparatus for accelerating a model is provided. The apparatus includes: an obtaining module, configured to obtain a model to be accelerated and acceleration-related parameters corresponding to the model to be accelerated; a determining module, configured to determine a target acceleration strategy corresponding to the model to be accelerated according to the acceleration-related parameters; a judging module, configured to determine whether there is a dependency relation between the model to be accelerated and a user data set; and a processing module, configured to, in response to there being a dependency between the model to be accelerated and the user data set, obtain a target user data set sent by a user, and obtain a target model by processing the model to be accelerated based on the target user data set and the target acceleration strategy.

According to a third aspect of the disclosure, an electronic device is provided. The electronic device includes: at least one processor and a memory communicatively connected to the at least one processor. The memory stores instructions executable by the at least one processor. When the instructions are executed by the at least one processor, the at least one processor is caused to implement the method for accelerating a model as described above.

According to a fourth aspect of the disclosure, a non-transitory computer-readable storage medium having computer instructions stored thereon is provided. The computer instructions are used to cause a computer to implement the method for accelerating a model as described above.

According to a fifth aspect of the disclosure, a computer program product including computer programs is provided. When the computer programs are executed by a processor, the method for accelerating a model as described above is implemented.

It should be understood that the content described in this section is not intended to identify key or important features of the embodiments of the disclosure, nor is it intended to limit the scope of the disclosure. Additional features of the disclosure will be easily understood from the following description.

The disclosure achieves at least the following beneficial effects. In the disclosure, the target acceleration strategy corresponding to the model to be accelerated is determined according to the acceleration-related parameters, the model to be accelerated is processed in combination with the target user data set sent by the user, and multi-framework and multi-heterogeneous hardware are adopted, which makes the model better adapt to user-specific data distribution and characteristics, and improves a generalization ability and accuracy of the model, so that a final deployed model is more lightweight, efficient and adaptable to various hardware and application scenarios, therefore reducing cost and complexity of model deployment.

### BRIEF DESCRIPTION OF THE DRAWINGS

The accompanying drawings are used to better understand this solution and do not constitute a limitation to the disclosure.

FIG. 1 is a schematic diagram of an exemplary implementation of a method for accelerating a model according to an exemplary embodiment of the disclosure.

FIG. 2 is a schematic diagram of an exemplary implementation of a method for accelerating a model according to an exemplary embodiment of the disclosure.

FIG. 3 is an overall flowchart of an exemplary implementation of a method for accelerating a model according to an exemplary embodiment of the disclosure.

FIG. 4 is a schematic diagram of an exemplary implementation of a method for accelerating a model according to an exemplary embodiment of the disclosure.

FIG. 5 is a block diagram of a method for accelerating a model according to an exemplary embodiment of the disclosure.

FIG. 6 is a schematic diagram of an interface for a method for accelerating a model according to an exemplary embodiment of the disclosure.

FIG. 7 is a schematic diagram of an apparatus for accelerating a model according to an exemplary embodiment of the disclosure.

FIG. 8 is a schematic diagram of an electronic device according to an exemplary embodiment of the disclosure.

### DETAILED DESCRIPTION

The following description of exemplary embodiments of the disclosure is provided in combination with the accompanying drawings, which includes various details of the embodiments of the disclosure to aid in understanding, and should be considered merely exemplary. Those skilled in the art should understand that various changes and modifications of the embodiments described herein can be made without departing from the scope and spirit of the disclosure. For the sake of clarity and brevity, descriptions of well-known functions and structures are omitted from the following description.

Deep learning is a new research direction in a field of machine learning (ML), which is introduced into ML to bring it closer to its original goal of artificial intelligence. DL learns intrinsic laws and representation levels of sample data, and information gained from these learning procedures can be very helpful in interpreting data such as texts, images, sounds, and the like. An ultimate goal of DL is to enable machines to have same analytical learning capabilities as humans and be able to recognize data such as texts, images, sounds, and the like. DL is a complex ML algorithm that has achieved results in speech and image recognition that far exceed previous related techniques.

Artificial intelligence (AI) is a subject of studying that causes computers to simulate certain thought processes and intelligent behaviors of human beings (e.g., learning, reasoning, thinking, planning, etc.), which includes techniques both at a hardware level and at a software level. AI hardware technology generally includes computer vision technology, speech recognition technology, natural language processing technology and learning/DL, big data processing technology, knowledge graph technology and other major aspects.

FIG. 1 is a schematic diagram of an exemplary implementation of a method for accelerating a model according to an exemplary embodiment of the disclosure. As illustrated in FIG. 1, the method for accelerating a model includes the following steps.

At step S101, a model to be accelerated and acceleration-related parameters corresponding to the model to be accelerated are obtained.

Optionally, in the disclosure, the model to be accelerated may be a CV model such as image classification, object detection, instance segmentation, semantic segmentation, etc., and various natural language processing (NLP) models.

The model to be accelerated may be a model based on different DL frameworks such as PaddlePaddle, PyTorch, TensorFlow, ONNX, and so on.

Optionally, the model to be accelerated and the acceleration-related parameters corresponding to the model to be accelerated are obtained based on an application programming interface (API).

Different types of models to be accelerated may correspond to different acceleration-related parameters. For example, the acceleration-related parameters may include parameters such as an acceleration strategy (intelligent combination, quantization, pruning, etc.), quantization accuracy, pruning ratio, target hardware, and the like.

For example, if a YoloV3_DarkNet53 model trained by PaddlePaddle needs to be accelerated using an acceleration strategy with INT8 quantization and deployed on an ARM CPU chip, input for calling the API is {PaddlePaddle, Yolo V3_DarkNet53, model file, arm, {‘slim_params’: {‘quantize’: ‘int8’}}}.

At step S102, a target acceleration strategy corresponding to the model to be accelerated is determined according to the acceleration-related parameters.

The target acceleration strategy includes, but is not limited to, one or more of quantization, pruning, sparsification and distillation.

As a possible implementation, the acceleration-related parameters carry a specified acceleration strategy. For example, if the above example specifies that an acceleration strategy with INT8 quantization is adopted for accelerating the model to be accelerated, the acceleration strategy with INT8 quantization is taken as the target acceleration strategy corresponding to the model to be accelerated.

At step S103, it is determined whether there is a dependency between the model to be accelerated and a user data set.

There is usually a certain dependency between the model to be accelerated and the user data set. In a DL task, models are usually trained based on a specific user data set, and the performance and generalization ability of the models are affected by the user data set. Therefore, when processing the model to be accelerated, it is necessary to consider whether there is a dependency between the model to be accelerated and the user data set.

At step S104, in response to there being a dependency between the model to be accelerated and the user data set, a target user data set sent by a user is obtained, and a target model is obtained by processing the model to be accelerated based on the target user data set and the target acceleration strategy.

In the disclosure, in response to there being a dependency between the model to be accelerated and the user data set, a data set provided by the user is taken as the target user data set, and the model to be accelerated is fine-tuned based on the target user data set to adapt to user-specific data distribution and characteristics. According to the target data set provided by the user and an application scenario, a best acceleration strategy is selected and adjusted to ensure that the model is accelerated without losing too much performance.

Embodiments of the disclosure provide a method for accelerating a model, in which a model to be accelerated and acceleration-related parameters corresponding to the model to be accelerated are obtained. A target acceleration strategy corresponding to the model to be accelerated is determined according to the acceleration-related parameters. It is determined whether there is a dependency between the model to be accelerated and a user data set. In response to there being a dependency between the model to be accelerated and the user data set, a target user data set sent by a user is obtained, and a target model is obtained by processing the model to be accelerated based on the target user data set and the target acceleration strategy. In the disclosure, the target acceleration strategy corresponding to the model to be accelerated is determined according to the acceleration-related parameters, the model to be accelerated is processed in combination with the target user data set sent by the user, and multi-framework and multi-heterogeneous hardware are adopted, which makes the model better adapt to user-specific data distribution and characteristics, and improves a generalization ability and accuracy of the model, so that a final deployed model is more lightweight, efficient and adaptable to various hardware and application scenarios, therefore reducing cost and complexity of model deployment.

Further, if it is determined that there is no dependency between the model to be accelerated and the user data set after judgment, the model to be accelerated is directly processed based on the target acceleration strategy to obtain the target model, such that the model to be accelerated does not need to be processed in combination with the user data set. The accelerated target model can be more readily applied to a variety of scenarios, including Internet of Things devices, mobile applications, edge computing, and so on, therefore expanding an application range and coverage of the model.

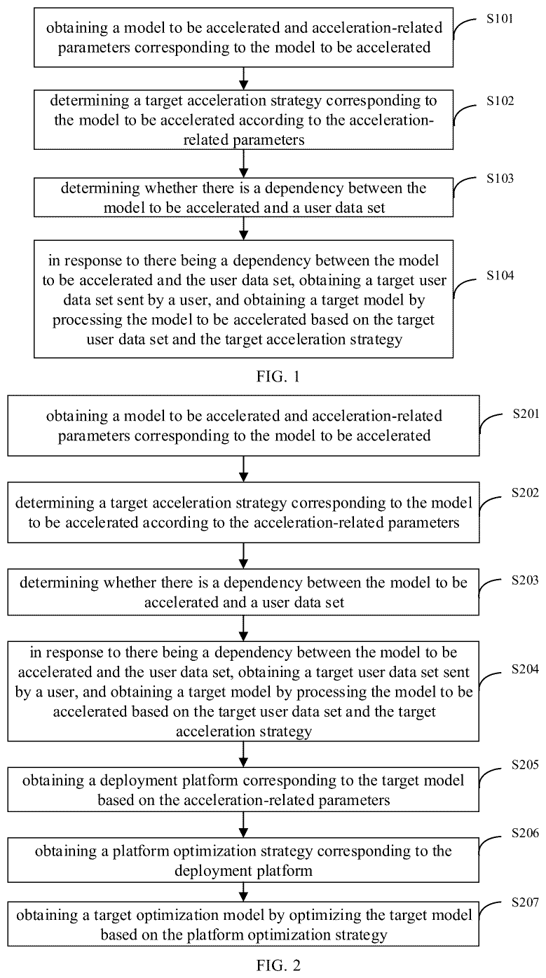

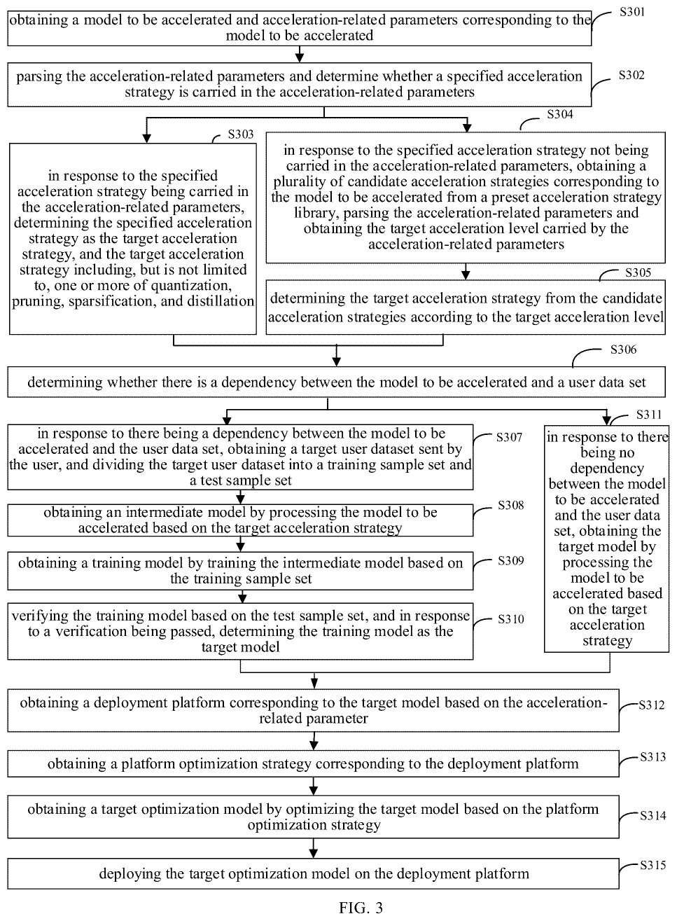

FIG. 2 is a schematic diagram of an exemplary implementation of a method for accelerating a model according to an exemplary embodiment of the disclosure. As illustrated in FIG. 2, the method for accelerating a model includes the following steps.

At step S201, a model to be accelerated and acceleration-related parameters corresponding to the model to be accelerated are obtained.

At step S202, a target acceleration strategy corresponding to the model to be accelerated is determined according to the acceleration-related parameters.

As a possible implementation, the acceleration-related parameters are parsed to determine whether the acceleration-related parameters carry a specified acceleration strategy. If the acceleration-related parameters carry a specified acceleration strategy, the specified acceleration strategy is taken as the target acceleration strategy. Generally, the acceleration-related parameters are set by the user, and if the user explicitly specifies an acceleration strategy in the acceleration-related parameters, the acceleration strategy is determined as the target acceleration strategy that can directly meet a customization requirement of the user, which can improve user satisfaction and ensure that an acceleration result meet the user's expectation. By directly using the specified acceleration strategy as the target acceleration strategy, acceleration processing can be performed quickly without the need to go through an additional strategy selection process, which helps to save time and computing resources, and improve an efficiency of the acceleration process.

As another possible implementation, if the acceleration-related parameters do not carry a specified acceleration strategy, a plurality of candidate acceleration strategies corresponding to the model to be accelerated are obtained from a preset acceleration strategy library, and a target acceleration strategy is determined from the plurality of candidate acceleration strategies.

For example, a plurality of acceleration strategies corresponding to each model are stored in advance in the acceleration strategy library. If a model 1 to be accelerated corresponds to an acceleration strategy 1, an acceleration strategy 2, and an acceleration strategy 3, then the acceleration strategy 1, the acceleration strategy 2 and the acceleration strategy 3 are the candidate acceleration strategies corresponding to the model 1 to be accelerated. After determining the candidate acceleration strategies corresponding to the model 1 to be accelerated, the acceleration-related parameters are parsed to obtain a target acceleration level carried in the acceleration-related parameters, and a target acceleration strategy is determined from the plurality of candidate acceleration strategies according to the target acceleration level. The target acceleration level refers to an acceleration degree set by the user in the acceleration-related parameters. For example, the acceleration level may include a low acceleration level, a medium acceleration level, and a high acceleration level. If the acceleration strategy 1 corresponds to the low acceleration level, the acceleration strategy 2 corresponds to the medium acceleration level, the acceleration strategy 3 corresponds to the high acceleration level, and the target acceleration level carried in the acceleration-related parameters is a high acceleration level, the acceleration strategy 3 is determined as the target acceleration strategy. In this implementation, as part of the acceleration-related parameters, the target acceleration level can be set by the user to an acceleration degree as needed. This flexibility allows the user to finely control the acceleration effect, and to balance between performance and precision.

At step S203, it is determined whether there is a dependency between the model to be accelerated and a user data set.

At step S204, in response to there being a dependency between the model to be accelerated and the user data set, a target user data set sent by a user is obtained, and a target model is obtained by processing the model to be accelerated based on the target user data set and the target acceleration strategy.

In the disclosure, in response to there being a dependency between the model to be accelerated and the user data set, the target user data set sent by the user is obtained and then divided into a training sample set and a test sample set. The training sample set is used for training the model, and the test sample set is used to verify the performance of the model.

The model to be accelerated is processed based on the target acceleration strategy, to obtain an intermediate model generated after processing, and during the processing process, acceleration techniques such as model compression, quantization, pruning, and the like may be involved.

The intermediate model is trained based on the training sample set to obtain a training model generated after training, to further optimize performance of the model based on the model after the acceleration process.

The training model is verified based on the test sample set, and if a verification is passed, the training model is determined as the target model. The target acceleration strategy corresponding to the model to be accelerated is determined according to the acceleration-related parameters. The model to be accelerated is processed in combination with the target user data set sent by the user, which makes the model better adapt to user-specific data distribution and characteristics, therefore improving a generalization ability and accuracy of the model.

Optionally, when processing the model to be accelerated based on the target acceleration strategy, a sensitivity analysis may be performed on the model to be accelerated to obtain sensitive nodes corresponding to the model to be accelerated, and remaining nodes other than the sensitive nodes in the model to be accelerated are processed based on the target acceleration strategy. In the disclosure, through the sensitivity analysis, the sensitive nodes in the model to be accelerated (i.e., nodes that have a large impact on the performance of the model or are mission-critical) are determined. These sensitive nodes are protected and not processed based on the target acceleration strategy, which ensures that the model maintains important functions and its accuracy while being accelerated.

At step S205, a deployment platform corresponding to the target model is obtained based on the acceleration-related parameters.

Generally, the user may set a deployment platform corresponding to the target model in the acceleration-related parameters. In the disclosure, the acceleration-related parameters are parsed to obtain the deployment platform corresponding to the target model. For example, the deployment platform may be an advanced risc machine (ARM), a central processing unit (CPU), a graphics processing unit (GPU), a field-programmable gate array (FPGA), an application-specific integrated circuit (ASIC) and on the like. Different platforms have different hardware characteristics and computing capabilities.

At step S206, a platform optimization strategy corresponding to the deployment platform is obtained.

For a selected deployment platform, a corresponding platform optimization strategy is formulated, including but not limited to, parallel computing optimization, memory access optimization, instruction set optimization, hardware accelerator utilization, etc. These strategies are formulated for characteristics of the target model and the deployment platform, to achieve optimal performance and efficiency.

Optionally, a mapping relationship between the deployment platform and its corresponding platform optimization strategies may be specified and saved in advance to be called subsequently.

At step S207, a target optimization model is obtained by optimizing the target model based on the platform optimization strategy.

According to the formulated platform optimization strategy, optimization processing is performed on the target model, such as, a model structure adjustment, a parameter quantization, network pruning, fixed-pointing, and the like to obtain the target optimization model. The target optimization model is more suitable for the characteristics of the target deployment platform and a computing capability and advantages of the platform can be fully utilized.

After obtaining the target optimization model, the target optimization model is deployed on the deployment platform and subjected to a model evaluation.

In the embodiments of the disclosure, not only the model is accelerated, but also a suitable deployment platform is selected according to the acceleration-related parameters and a corresponding platform optimization strategy is formulated to optimize the target model, to obtain an optimized model with the best performance on the target deployment platform, so as to give full play to potential of a hardware platform, therefore improving the deployment efficiency and performance of the model.

Further, in the execution process of the embodiments of the disclosure, an acceleration log of the model to be accelerated is generated in real time and stored in a log system. After the target optimization model is obtained, an optimization result of the target model is reported, to capture various abnormal situations and error messages during the model acceleration and optimization processes, which helps to detect and solve problems in time and facilitates the management and maintenance of the model.

FIG. 3 is an overall flowchart of an exemplary implementation of a method for accelerating a model according to an exemplary embodiment of the disclosure. As illustrated in FIG. 3, the method for accelerating a model includes the following steps.

At step S301, a model to be accelerated and acceleration-related parameters corresponding to the model to be accelerated are obtained.

At step S302, the acceleration-related parameters are parsed, and it is determined whether a specified acceleration strategy is carried in the acceleration-related parameters.

At step S303, in response to the specified acceleration strategy being carried in the acceleration-related parameters, the specified acceleration strategy is determined as a target acceleration strategy, and the target acceleration strategy includes, but is not limited to, one or more of quantization, pruning, sparsification, and distillation.

At step S304, in response to a specified acceleration strategy not being carried in the acceleration-related parameters, a plurality of candidate acceleration strategies corresponding to the model to be accelerated are obtained from a preset acceleration strategy library, and the acceleration-related parameters are parsed, and a target acceleration level carried in the acceleration-related parameters is obtained.

At step S305, the target acceleration strategy is determined from the plurality of candidate acceleration strategies according to the target acceleration level.

With regard to the specific implementations of steps S301 to S305, reference may be made to the specific introduction of the relevant portions of the above embodiments, which will not be repeated herein.

At step S306, it is determined whether there is a dependency between the model to be accelerated and a user data set.

At step S307, in response to there being a dependency between the model to be accelerated and the user data set, a target user data set sent by a user is obtained and divided into a training sample set and a test sample set.

At step S308, an intermediate model is obtained by processing the model to be accelerated based on the target acceleration strategy.

At step S309, a training model is obtained by training the intermediate model based on the training sample set.

At step S310, the training model is verified based on the test sample set, and in response to a verification being passed, the training model is determined as the target model.

At step S311, in response to there being no dependency between the model to be accelerated and the user data set, the target model is obtained by processing the model to be accelerated based on the target acceleration strategy.

With regard to the specific implementations of steps S306 to S311, reference may be made to the specific introduction of the relevant portions of the above embodiments, which will not be repeated herein.

At step S312, a deployment platform corresponding to the target model is obtained based on the acceleration-related parameters.

At step S313, a platform optimization strategy corresponding to the deployment platform is obtained.

At step S314, a target optimization model is obtained by optimizing the target model based on the platform optimization strategy.

At step S315, the target optimization model is deployed on the deployment platform.

With regard to the specific implementations of steps S312 to S315, reference may be made to the specific introduction of the relevant portions of the above embodiments, which will not be repeated herein.

In the disclosure, the target acceleration strategy corresponding to the model to be accelerated is determined according to the acceleration-related parameters, the model to be accelerated is processed in combination with the target user data set sent by the user, and multi-framework and multi-heterogeneous hardware are adopted, which makes the model better adapt to user-specific data distribution and characteristics, and improves a generalization ability and accuracy of the model, so that a final deployed model is more lightweight, efficient and adaptable to various hardware and application scenarios, therefore reducing cost and complexity of model deployment.

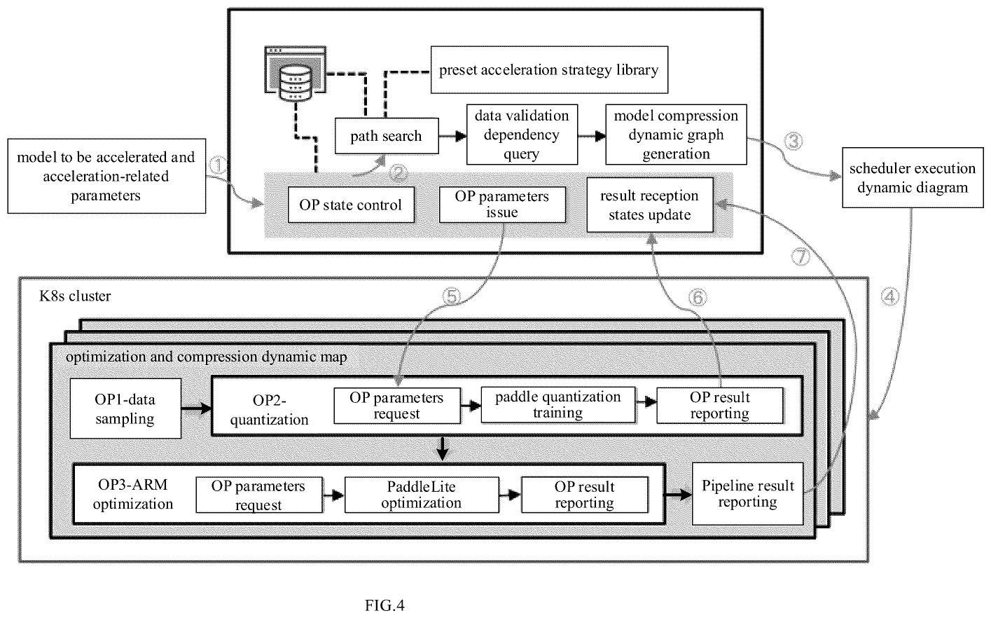

FIG. 4 is a schematic diagram of an exemplary implementation of a method for accelerating a model according to an exemplary embodiment of the disclosure. As illustrated in FIG. 4, the method for accelerating a model includes the following steps.

A model to be accelerated and acceleration-related parameters corresponding to the model to be accelerated are obtained based on an API. For example, if a YoloV3_DarkNet53 model trained by PaddlePaddle needs to be accelerated using an acceleration strategy with INT8 quantization and deployed on an ARM CPU chip, input for calling the API is {PaddlePaddle, YoloV3_DarkNet53, model file, arm, {‘slim_params’: {‘quantize’: ‘int8’}}}. That is, the acceleration strategy with INT8 quantization is used as the target acceleration strategy corresponding to the model to be accelerated.

It is determined whether there is a dependency between the model to be accelerated and a user data set. In response to there being a dependency between the model to be accelerated and the user data set, data sampling is performed firstly, i.e., obtaining a target user data set sent by the user and dividing it into a training sample set and a test sample set. Paddle quantization training is performed for the model to be accelerated based on the target acceleration strategy, and a training model is generated after acceleration process and training. The training model is verified based on the test sample set, and if a verification is passed, the training model is used as the target model and a Paddle quantization training result is reported.

Since the model is finally deployed on an ARM CPU chip, for the ARM CPU chip, an optimization step of paddlelite opt is added after quantization in the disclosure.

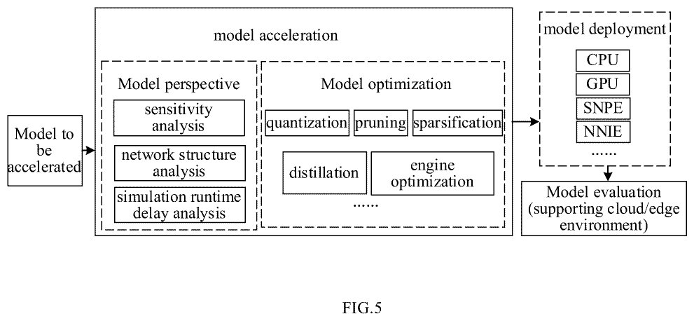

FIG. 5 is a block diagram of a method for accelerating a model according to an exemplary embodiment of the disclosure. As illustrated in FIG. 5, based on an API, a model to be accelerated and acceleration-related parameters corresponding to the model to be accelerated are obtained. Model perspective is performed on the model to be accelerated, such as model sensitivity analysis, model network structure analysis, and model simulation runtime delay analysis, etc., to determine a target acceleration strategy corresponding to the model to be accelerated. A target model is obtained by processing the model to be accelerated based on the target acceleration strategy. A deployment platform corresponding to the target model and a platform optimization strategy corresponding to the deployment platform are obtained. The target model is optimized based on the platform optimization strategy to obtain a target optimization model, and then the target optimization model is deployed on the deployment platform.

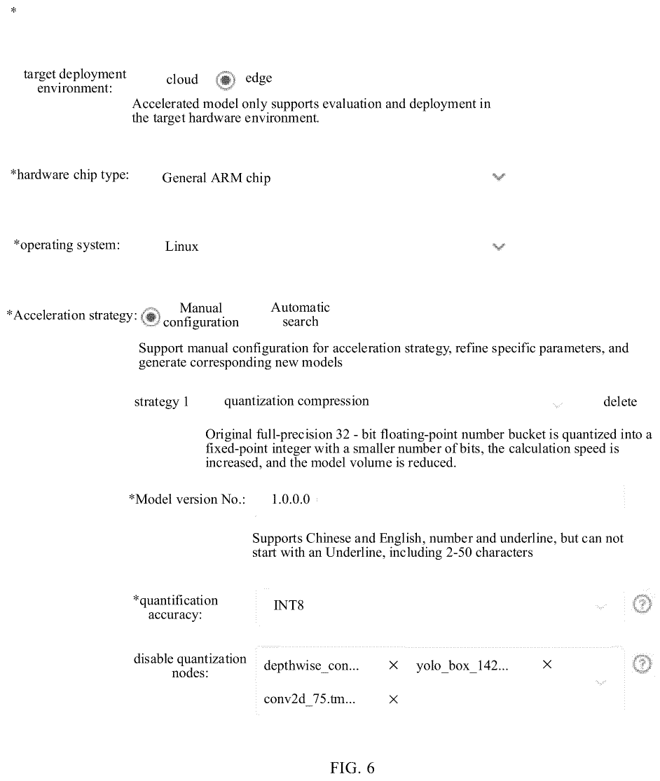

FIG. 6 is a schematic diagram of an interface for a method for accelerating a model according to an exemplary embodiment of the disclosure. As illustrated in FIG. 6, the user can manually set the acceleration-related parameters to achieve flexible acceleration of the model.

FIG. 7 is a schematic diagram of an apparatus 700 for accelerating a model according to an exemplary embodiment of the disclosure. As illustrated in FIG. 7, the apparatus 700 for accelerating a model includes:
an obtaining module 701, configured to obtain a model to be accelerated and acceleration-related parameters corresponding to the model to be accelerated;
a determining module 702, configured to determine a target acceleration strategy corresponding to the model to be accelerated according to the acceleration-related parameters;
a judging module 703, configured to determine whether there is a dependency between the model to be accelerated and a user data set; and
a processing module 704, configured to, in response to there being a dependency between the model to be accelerated and the user data set, obtain a target user data set sent by a user, and obtain a target model by processing the model to be accelerated based on the target user data set and the target acceleration strategy.

The apparatus determines the target acceleration strategy corresponding to the model to be accelerated according to the acceleration-related parameters, processes the model to be accelerated in combination with the target user data set sent by the user, and adopts multi-framework and multi-heterogeneous hardware, which makes the model better adapt to user-specific data distribution and characteristics, and improves a generalization ability and accuracy of the model, so that a final deployed model is more lightweight, efficient and adaptable to various hardware and application scenarios, thereby reducing cost and complexity of model deployment.

The processing module is configured to: in response to there being no dependency between the model to be accelerated and the user data set, obtain the target model by processing the model to be accelerated based on the target acceleration strategy.

The processing module is configured to: obtain a deployment platform corresponding to the target model based on the acceleration-related parameters; obtain a platform optimization strategy corresponding to the deployment platform; and obtain a target optimization model by optimizing the target model based on the platform optimization strategy.

The processing module is configured to: divide the target user data set into a training sample set and a test sample set; obtain an intermediate model by processing the model to be accelerated based on the target acceleration strategy; obtain a training model by training the intermediate model based on the training sample set; and verify the training model based on the test sample set, and if a verification is passed, determine the training model as the target model.

The determining module is configured to: parse the acceleration-related parameters, and determine whether the acceleration-related parameters carry a specified acceleration strategy; and in response to the acceleration-related parameters carrying a specified acceleration strategy, determine the specified acceleration strategy as the target acceleration strategy.

The determining module is configured to: in response to the acceleration-related parameters not carrying a specified acceleration strategy, obtain a plurality of candidate acceleration strategies corresponding to the model to be accelerated from a preset acceleration strategy library; and determine a target acceleration strategy from the plurality of candidate acceleration strategies.

The determining module is configured to: parse the acceleration-related parameters, and obtain a target acceleration level carried in the acceleration-related parameters; and determine the target acceleration strategy from the plurality of candidate acceleration strategies according to the target acceleration level.

The target acceleration strategy includes, but is not limited to, one or more of quantization, pruning, sparsification, and distillation.

The processing module is configured to: obtain sensitive nodes corresponding to the model to be accelerated by performing a sensitivity analysis on the model to be accelerated; and remaining nodes other than the sensitive nodes in the model to be accelerated are processed based on the target acceleration strategy.

The processing module is configured to: deploy the target optimization model on the deployment platform.

The apparatus also includes: an evaluating module, configured to perform a model evaluation for the target optimization model.

The processing module is configured to: generate an acceleration log of the model to be accelerated and store the acceleration log in a log system.

The processing module is configured to: report an optimization result of the target model.

The collection, storage, and application of user's personal information involved in the technical solutions of the disclosure are all in compliance with relevant laws and regulations and do not violate public order and morality.

According to the embodiments of the disclosure, the disclosure also provides an electronic device, a readable storage medium and a computer program product.

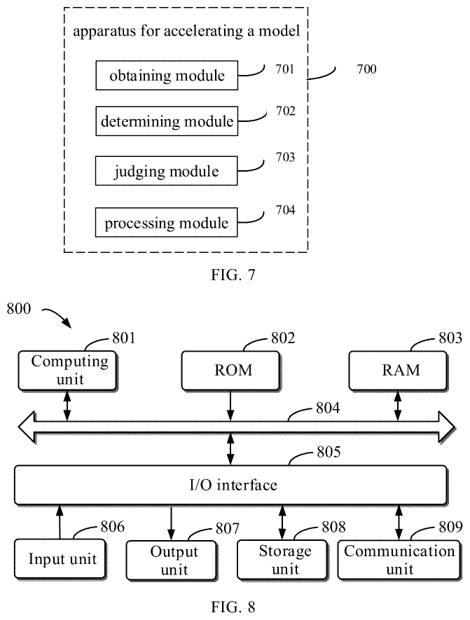

FIG. 8 is a schematic diagram of an electronic device 800 according to an exemplary embodiment of the disclosure. The electronic device is intended to represent various forms of digital computers, such as a laptop computer, a desktop computer, a workbench, a personal digital assistant, a server, a blade server, a mainframe computer, and other suitable computers. The electronic device may also represent various forms of mobile devices, such as a personal digital processor, a cellular phone, a smart phone, a wearable device, and other similar computing devices. The components shown here, their connections and relations, and their functions are merely examples, and are not intended to limit the implementations of the disclosure described and/or required herein.

As illustrated in FIG. 8, the electronic device 800 includes a computing unit 801 for performing various appropriate actions and processes based on computer programs stored in a read-only memory (ROM) 802 or computer programs loaded from a storage unit 808 to a random access memory (RAM) 803. In the RAM 803, various programs and data required for the operation of the device 800 are stored. The computing unit 801, the ROM 802, and the RAM 803 are connected to each other through a bus 804. An input/output (I/O) interface 805 is also connected to the bus 804.

Components in the device 800 are connected to the I/O interface 805, including: an inputting unit 806, such as a keyboard, a mouse, and the like; an outputting unit 807, such as various types of displays, speakers, and the like; a storage unit 808, such as a disk, an optical disk, and the like; and a communication unit 809, such as a network card, a modem, and a wireless communication transceiver, and the like. The communication unit 809 allows the device 800 to exchange information/data with other devices through a computer network such as the Internet and/or various telecommunication networks.

The computing unit 801 may be various general-purpose and/or dedicated processing components with processing and computing capabilities. Some examples of computing unit 801 include, but are not limited to, a CPU, a graphics processing unit (GPU), various dedicated AI computing chips, various computing units that run ML model algorithms, and a Digital Signal Processor (DSP), and any appropriate processor, controller and microcontroller. The computing unit 801 executes the various methods and processes described above, such as the method for accelerating a model. For example, in some embodiments, the method for accelerating a model may be implemented as a computer software program, which is tangibly contained in a machine-readable medium, such as the storage unit 808. In some embodiments, part or all of the computer program may be loaded and/or installed on the device 800 via the ROM 802 and/or the communication unit 809. When the computer program is loaded on the RAM 803 and executed by the computing unit 801, one or more steps of the method for accelerating a model described above may be executed. Alternatively, in other embodiments, the computing unit 801 may be configured to perform the method for accelerating a model in any other suitable manner (for example, by means of firmware).

Various implementations of the systems and techniques described above may be implemented by a digital electronic circuit system, an integrated circuit system, a FPGA, an ASIC, an application specific standard product (ASSP), a system on chip (SOC), a complex programmable logic device (CPLD), a computer hardware, a firmware, a software, and/or a combination thereof. These various embodiments may be implemented in one or more computer programs, the one or more computer programs may be executed and/or interpreted on a programmable system including at least one programmable processor, which may be a dedicated or general programmable processor for receiving data and instructions from the storage system, at least one input device and at least one output device, and transmitting the data and instructions to the storage system, the at least one input device and the at least one output device.

Program codes configured to implement the method of the disclosure may be written in any combination of one or more programming languages. These program codes may be provided to processors or controllers of general-purpose computers, dedicated computers, or other programmable data processing devices, so that the program codes, when executed by the processors or controllers, enable the functions/operations specified in the flowcharts and/or block diagrams to be implemented. The program codes may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in combination with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage medium include electrical connections based on one or more wires, portable computer disks, hard disks, RAMs, ROMs, electrically programmable ROMs (EPROMs), flash memories, fiber optics, compact disc ROMs (CD-ROMs), optical storage devices, magnetic storage devices, or any suitable combination of the foregoing.

In order to provide interactions with a user, the systems and techniques described herein may be implemented on a computer having a display device (e.g., a cathode ray tube (CRT) or a liquid crystal display (LCD) monitor for displaying information to the user); and a keyboard and pointing device (such as a mouse or trackball) through which the user may provide input to the computer. Other kinds of devices may also be used to provide interactions with the user. For example, feedback provided to the user may be any form of sensory feedback (e.g., visual feedback, auditory feedback, or tactile feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through the graphical user interface or the web browser the user can interact with the implementations of the systems and technologies described herein), or include such background components, intermediate computing components, or any combination of front-end components. The components of the system may be interconnected by any form or medium of digital data communication (e.g., a communication network). Examples of the communication network include: local area network (LAN), wide area network (WAN), and the Internet.

A computer system may include a client and a server. The client and server are generally remote from each other and interacting through a communication network. The client-server relationship is generated by computer programs having a client-server relationship with each other running on respective computers. The server may be a cloud server, a server of distributed system or a server combined with block-chain.

It should be understood that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of the disclosure shall be included in the protection scope of the disclosure.

What is claimed is:

1. A method for accelerating a model, comprising:
obtaining a model to be accelerated and acceleration-related parameters corresponding to the model to be accelerated;
determining a target acceleration strategy corresponding to the model to be accelerated according to the acceleration-related parameters;
determining whether there is a dependency between the model to be accelerated and a user data set; and
in response to there being a dependency between the model to be accelerated and the user data set, obtaining a target user data set sent by a user, and obtaining a target model by processing the model to be accelerated based on the target user data set and the target acceleration strategy.

2. The method of claim 1, further comprising:
in response to there being no dependency between the model to be accelerated and the user data set, obtaining the target model by processing the model to be accelerated based on the target acceleration strategy.

3. The method of claim 1 or 2, after obtaining the target model, further comprising:
obtaining a deployment platform corresponding to the target model based on the acceleration-related parameters;
obtaining a platform optimization strategy corresponding to the deployment platform; and
obtaining a target optimization model by optimizing the target model based on the platform optimization strategy.

4. The method of claim 1, wherein obtaining the target model by processing the model to be accelerated based on the target user data set and the target acceleration strategy, comprises:
dividing the target user data set into a training sample set and a test sample set;
obtaining an intermediate model by processing the model to be accelerated based on the target acceleration strategy;
obtaining a training model by training the intermediate model based on the training sample set; and
verifying the training model based on the test sample set, and in response to a verification being passed, determining the training model as the target model.

5. The method of claim 1, wherein determining the target acceleration strategy corresponding to the model to be accelerated according to the acceleration-related parameters, comprises:
parsing the acceleration-related parameters, and determining whether a specified acceleration strategy is carried in the acceleration-related parameters; and
in response to the specified acceleration strategy being carried in the acceleration-related parameters, determining the specified acceleration strategy as the target acceleration strategy.

6. The method of claim 5, further comprising:
in response to the specified acceleration strategy not being carried in the acceleration-related parameters, obtaining a plurality of candidate acceleration strategies corresponding to the model to be accelerated from a preset acceleration strategy library; and
determining the target acceleration strategy from the plurality of candidate acceleration strategies.

7. The method of claim 6, wherein determining the target acceleration strategy from the plurality of candidate acceleration strategies, comprises:
parsing the acceleration-related parameters, and obtaining a target acceleration level carried in the acceleration-related parameters; and
determining the target acceleration strategy from the plurality of candidate acceleration strategies according to the target acceleration level.

8. The method of any one of claims 5-7, wherein the target acceleration strategy comprises, but is not limited to, one or more of quantization, pruning, sparsification, and distillation.

9. The method of claim 2 or 4, wherein processing the model to be accelerated based on the target acceleration strategy, comprises:
obtaining sensitive nodes corresponding to the model to be accelerated by performing a sensitivity analysis on the model to be accelerated; and
processing remaining nodes other than the sensitive nodes in the model to be accelerated based on the target acceleration strategy.

10. The method of claim 3, wherein after obtaining the target optimization model, the method further comprises:
deploying the target optimization model on the deployment platform.

11. The method of claim 10, wherein after deploying the target optimization model on the deployment platform, the method further comprises:
performing a model evaluation for the target optimization model.

12. The method of claim 1 or 2, wherein after obtaining the target model, the method further comprises:
generating an acceleration log of the model to be accelerated and storing the acceleration log in a log system.

13. The method of claim 3, wherein after obtaining the target optimization model, the method further comprises:
reporting an optimization result of the target model.

14. An apparatus for accelerating a model, comprising:
an obtaining module, configured to obtain a model to be accelerated and acceleration-related parameters corresponding to the model to be accelerated;
a determining module, configured to determine a target acceleration strategy corresponding to the model to be accelerated according to the acceleration-related parameters;
a judging module, configured to determine whether there is a dependency between the model to be accelerated and a user data set; and
a processing module, configured to, in response to there being a dependency between the model to be accelerated and the user data set, obtain a target user data set sent by a user, and obtain a target model by processing the model to be accelerated based on the target user data set and the target acceleration strategy.

15. The apparatus of claim 14, wherein the processing module is configured to:
in response to there being no dependency between the model to be accelerated and the user data set, obtain the target model by processing the model to be accelerated based on the target acceleration strategy.

16. The apparatus of claim 14 or 15, wherein the processing module is further configured to:
obtain a deployment platform corresponding to the target model based on the acceleration-related parameters;
obtain a platform optimization strategy corresponding to the deployment platform; and
obtain a target optimization model by optimizing the target model based on the platform optimization strategy.

17. The apparatus of claim 14, wherein the processing module is further configured to:
divide the target user data set into a training sample set and a test sample set;
obtain an intermediate model by processing the model to be accelerated based on the target acceleration strategy;
obtain a training model by training the intermediate model based on the training sample set; and
verify the training model based on the test sample set, and in response to a verification being passed, determine the training model as the target model.

18. The apparatus of claim 14, wherein the determining module is configured to:
parse the acceleration-related parameters, and determine whether a specified acceleration strategy is carried in the acceleration-related parameters; and
in response to the specified acceleration strategy being carried in the acceleration-related parameters, determine the specified acceleration strategy as the target acceleration strategy.

19. The apparatus of claim 18, wherein the determining module is further configured to:
in response to the specified acceleration strategy not being carried in the acceleration-related parameters, obtain a plurality of candidate acceleration strategies corresponding to the model to be accelerated from a preset acceleration strategy library; and
determine the target acceleration strategy from the plurality of candidate acceleration strategies.

20. The apparatus of claim 19, wherein the determining module is further configured to:
parse the acceleration-related parameters, and obtain a target acceleration level carried in the acceleration-related parameter; and
determine the target acceleration strategy from the plurality of candidate acceleration strategies according to the target acceleration rate.

21. The apparatus of any one of claims 18-20, wherein the target acceleration strategy comprises, but is not limited to, one or more of quantization, pruning, sparsification, and distillation.

22. The apparatus of claim 15 or 17, wherein the processing module is further configured to:
obtain sensitive nodes corresponding to the model to be accelerated by performing a sensitivity analysis on the model to be accelerated; and
processing remaining nodes other than the sensitive nodes in the model to be accelerated based on the target acceleration strategy.

23. The apparatus of claim 16, wherein the processing module is further configured to:
deploy the target optimization model on the deployment platform.

24. The apparatus of claim 23, further comprising:
an evaluating module, configured to perform a model evaluation for the target optimization model.

25. The apparatus of claim 14 or 15, wherein the processing module is further configured to:
generate an acceleration log of the model to be accelerated and store the acceleration log in a log system.

26. The apparatus of claim 25, wherein the processing module is configured to:
report an optimization result of the target model.

27. An electronic device, comprising:
at least one processor; and
a memory communicatively connected to the at least one processor;
wherein the memory stores instructions executable by the at least one processor, when the instructions are executed by the at least one processor, the at least one processor is caused to implement the method of any one of claims 1-13.

28. A non-transitory computer-readable storage medium having computer instructions stored thereon, wherein the computer instructions are used to cause a computer to implement the method of any one of claims 1-13.

29. A computer program product comprising computer programs, wherein when the computer programs are executed by a processor, the steps of the method of any one of claims 1-13 are implemented.
